(19) United States
(12) Patent Application Publication
(10) Pub. No.: US 2023/0274869 A1
(43) Pub. Date: Aug. 31, 2023

(54) MAGNETIC COMPONENT WITH CONTROLLED LEAKAGE FLUX

(71) Applicant: VALEO SIEMENS EAUTOMOTIVE FRANCE SAS, Cergy (FR)

(72) Inventors: Boris BOUCHEZ, Drammen (NO); Stephane FONTAINE, Drammen (NO)

(73) Assignee: Valeo eAutomotive France SAS, Cergy (FR)

(21) Appl. No.: 18/007,266

(22) PCT Filed: Jun. 23, 2021
(86) PCT No.: PCT/EP2021/067109

§ 371 Date: Jan. 27, 2023

(30) Foreign Application Priority Data
Jul. 29, 2020 (FR) FR2007993

(51) Int. Cl. H01F 27/08; H01F 27/26; H01F 27/28; H01F 27/34

(52) U.S. Cl. CPC H01F 27/08; H01F 27/263; H01F 27/28; H01F 27/346

(57) ABSTRACT

A magnetic component includes two ferromagnetic half-cores stacked and superposed to form a ferromagnetic core comprising three legs, namely two first legs and one second leg. Each leg is formed from two facing half-legs separated by a gap, and each leg incudes a primary winding and a secondary winding having a winding direction, on each of the half-legs forming the leg, respectively. The magnetic component is characterized in that, on the second leg, the primary winding and the secondary winding and their winding directions are inverted with respect to those of the first legs.

### TECHNICAL FIELD

The present invention relates to the field of magnetic components, and in particular of electric transformers.

The present invention more particularly relates to the field of electric transformers, for example electric transformers integrated into resonant voltage converters or any other type of power converter, or into electric chargers. In particular, the present invention pertains to a magnetic component such as a three-phase electric transformer.

### PRIOR ART

An electric transformer allows electrical energy to be transferred from a primary circuit to a secondary circuit.

As is known, in an electric transformer, a magnetic core and coils through which flows an electric current that generates a magnetic field allowing electrical energy to be transferred from the primary circuit to the secondary circuit are used. More precisely, in an electric transformer, and in particular in a power converter employing a magnetizing inductance or in a resonant power converter, there is a primary coil and a secondary coil, which are formed by windings around a magnetic core, and between which electrical energy is transferred.

More particularly, in a three-phase electric transformer, there are three primary windings and three secondary windings wound around various segments of a ferromagnetic core of suitable shape. E-shaped ferromagnetic cores, one example of which is shown in FIG. 1, and triangular ferromagnetic cores, one example of which is shown in FIG. 2, are in particular known.

All electric transformers have a leakage inductance, which results in a lower efficiency because some of the magnetic flux created in the primary circuit is not coupled to the windings of the secondary circuit. Additional losses may further appear in the primary and secondary windings. In the case of non-resonant voltage converters, over-voltages may moreover occur. The geometry of the coils of an electric transformer, and likewise the magnetic materials used for the magnetic core, or indeed the geometry of said magnetic core, in particular, are configured to meet electric and magnetic criteria. One objective of the dimensioning of an electric transformer is in particular control of the value of the leakage inductance of the electric transformer.

Two main ways of manufacturing such electric transformers, in particular when they are three-phase, are known. In the example of FIG. 1, the coils are flat and the primary winding 310 and the secondary winding 320 form two superposed layers in each leg 31, 32, 33 of the ferromagnetic core 30. Such a known electric transformer 3, assembled using a flat-winding technique, has a low leakage inductance. However, parasitic capacitance is in this case very high both in the primary circuit and in the secondary circuit. Moreover, cooling of the winding placed under, or in other words the “buried” winding, is very difficult.

On the same type of E-shaped ferromagnetic core, it is also possible to produce stacked windings. One advantage of this known architecture resides in the fact that it is easy to integrate and to cool. Such an architecture however has a high leakage inductance.

Another known way of producing a three-phase electric transformer 4 consists in placing the windings on an equilateral-triangle-shaped ferromagnetic core, the legs thus being arranged at 60° from each other, as shown in FIG. 2.

Such a triangular structure is however difficult to integrate mechanically.

In this context, it is known, with an architecture based on windings stacked on an E-shaped ferromagnetic core, to use the leakage inductance to make the resonant inductance work and therefore to promote transfer of energy from the primary windings to the secondary windings. Thus, advantage is taken of the seemingly disadvantageous leakage inductance.

This known principle is illustrated in FIG. 4. As may be seen in FIG. 4, the primary windings are placed on the top E-shaped ferromagnetic half-core and the secondary windings are placed on the bottom E-shaped ferromagnetic half-core.

The technical problem related to implementation of this technology resides in the fact that the magnetic leakage flux does not loop. Specifically, it gets concentrated in the legs and “jumps” from the lateral legs 21, 23 to the central leg 22, as illustrated in FIG. 4. The flux lines are thus parallel to the gaps.

There is therefore a need for a three-phase electric transformer that is easy to integrate and to cool and the leakage inductance of which is controlled.

### PRESENTATION OF THE INVENTION

To this end, one subject of the invention is a magnetic component comprising two ferromagnetic half-cores stacked and superposed to form a ferromagnetic core comprising three legs, namely two first legs and one second leg, each leg being formed from two facing half-legs separated by a gap, each leg comprising a primary winding and a secondary winding having a winding direction, on each of the half-legs forming said leg, respectively, the magnetic component being characterized in that, on the second leg, the primary winding and the secondary winding and their winding directions are inverted with respect to those of the first legs.

In particular, the first legs may be lateral legs and the second leg a central leg.

According to one embodiment, the two ferromagnetic half-cores have what is referred to as a “triangular” arrangement in which, in each ferromagnetic half-core, the three legs forming each half-core are at 60° from each other, respectively. In particular, the three legs forming each half-core are located at the vertices of an equilateral triangle.

Advantageously, the two ferromagnetic half-cores have an E shape.

The invention also pertains to an electric transformer comprising a magnetic component such as briefly described above.

The invention also relates to a piece of electric equipment comprising an electric transformer such as briefly described above.

Advantageously, said piece of electric equipment comprises a cooling module comprising a cavity forming a cooling pool housing said electric transformer.

According to one embodiment, said piece of electric equipment forms an electric charger.

According to another embodiment, said piece of electric equipment forms a power converter.

### PRESENTATION OF THE FIGURES

The invention will be better understood on reading the following description, which is given merely by way of example, and on making reference to the appended drawings, which have been given by way of non-limiting example, and in which identical references have been used to designate similar objects, and in which:

FIG. 1 is a schematic representation of a known first electric transformer with primary and secondary windings placed in superposed layers;

FIG. 2 is a schematic representation of a known first electric transformer with primary and secondary windings placed on a triangular ferromagnetic core;

FIG. 3 is a circuit diagram of an electric transformer;

FIG. 4 is a schematic representation of an E-shaped electric transformer, having the known drawbacks;

FIG. 5 is a schematic representation of one example of an electric transformer according to the invention, assembled on an E-shaped ferromagnetic core.

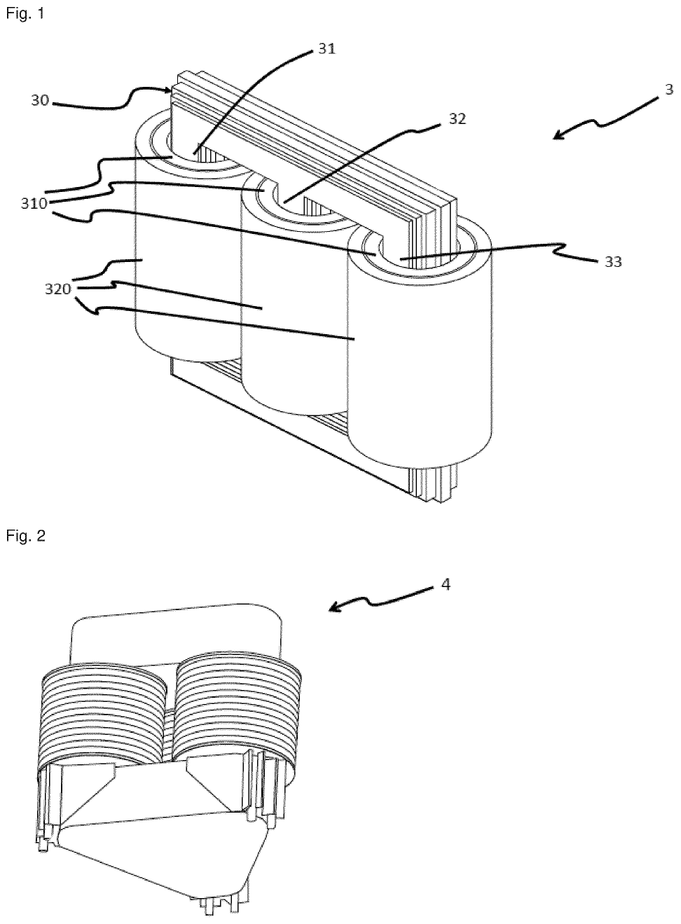

It will be noted that the figures illustrate the invention in a detailed manner, with a view to allowing implementation of the invention, said figures possibly of course serving to better define the invention where appropriate.

### DETAILED DESCRIPTION OF THE INVENTION

The invention relates to a magnetic component, and in particular a three-phase transformer.

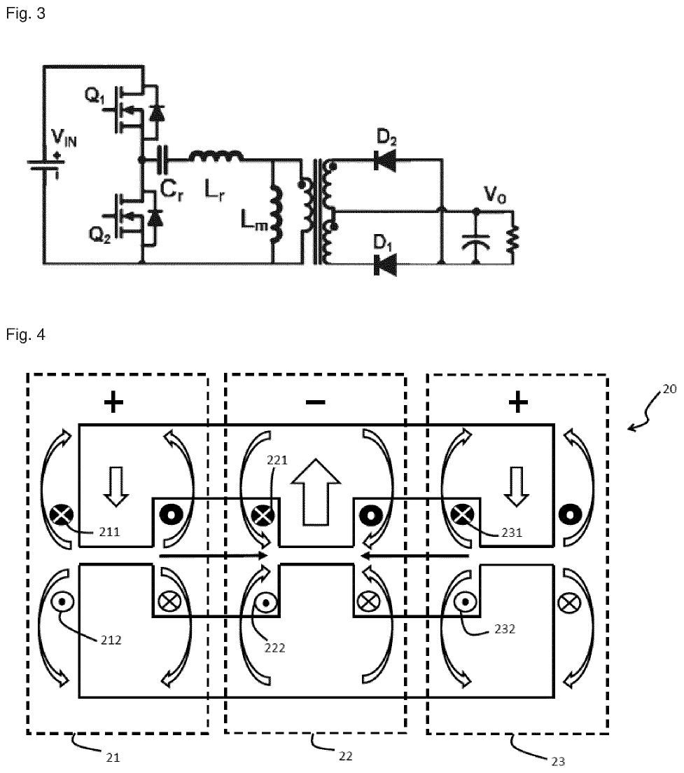

FIG. 3 shows an equivalent circuit diagram of a resonant voltage-converter circuit comprising an electric transformer, for converting an input voltage V_{IN} into an output voltage V_{O}. The electric transformer comprises primary and secondary windings. The magnetic flux created by the flow of an electric current through the primary winding allows energy to be transferred to the secondary circuit. In the primary circuit, there is an LLC resonant circuit that is formed from a resonant capacitor Cr, from a resonant inductor Lr and from a magnetizing inductor Lm that may be integrated into the electric transformer. The electric transformer is controlled by a half-bridge of switches Q1, Q2 that is connected to the primary winding. The diodes D1, D2 connected to the secondary circuit allow return currents to be avoided.

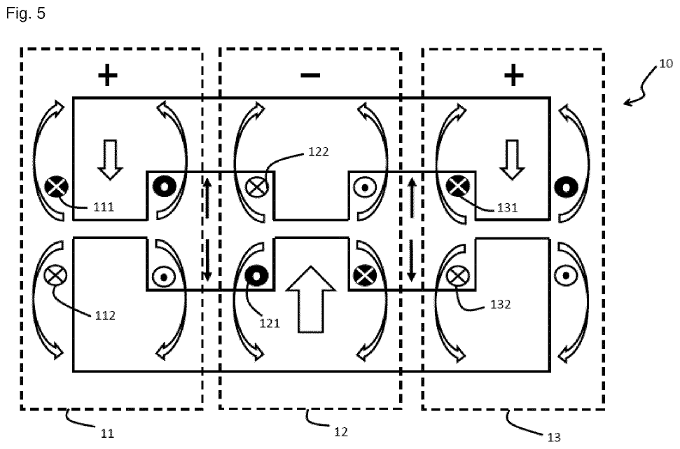

FIGS. 4 and 5 shows schematic representations of a prior-art electric transformer 20 and of one example of an electric transformer 10 according to the invention, respectively, both these transformers being based on an E-shaped ferromagnetic core. Said ferromagnetic core is formed from two half-cores having an E shape, stacked face to face.

The ferromagnetic core has three legs 11, 12, 13, 21, 22, 23, namely two lateral legs 11, 13, 21, 23 and one central leg 12, 22. Each leg 11, 12, 13, 21, 22, 23 is formed from two facing half-legs separated by a gap. Each leg 11, 12, 13, 21, 22, 23 corresponds to one phase of three-phase electric transformer 20 and 10, respectively. In an electric transformer based on an E-shaped core, each arm of the E, or in other words each leg 11, 12, 13, 21, 22, 23 of said ferromagnetic core, corresponds to one phase of the electric transformer. Similarly, in a triangular transformer, each leg corresponding to one vertex of the triangle is connected to one phase of the electric transformer.

In FIG. 4, the windings 211, 212, 221, 222, 231, 232 are wound in the same direction for all of the primary windings, which are all located on the top half-legs, and for the secondary windings, which are all located on the bottom half-legs, respectively.

The drawback of this architecture that represents the prior art and that is schematically shown in FIG. 4 resides in the fact that some of the leakage magnetic flux is directed in opposite directions. This magnetic flux does not loop in the leg corresponding to its phase but jumps from one leg to the next. In particular, magnetic flux is generated parallel to the gaps and jumps from each lateral leg 21, 23 to the central leg 22. In other words, coupling occurs between each lateral leg 21, 23 and the central leg 22.

This leads to an increase in losses and to a risk of overheating at the center of the electric transformer 20, in the central leg 22.

One way of avoiding this coupling would be to move the lateral legs 21, 23 further from the central leg 22, in order to prevent these jumps of magnetic flux from the lateral legs 21, 23 to the central leg 22, but the size of the ferromagnetic core would thus be increased. However, this would obviously induce an increase in the bulk of the electric transformer, which would be disadvantageous.

FIG. 5 shows the solution proposed by the present invention, according to one embodiment. In the central leg 12, the primary winding 121 and the secondary winding 122 are inverted and the winding direction of these primary and secondary windings 121, 122 is inverted. The primary winding 121 of the central leg 12 is thus located on the same side of the ferromagnetic core as the secondary windings 112, 132 of the lateral legs 11, 13. Reciprocally, the secondary winding 122 of the central leg 12 is thus located on the same side of the ferromagnetic core as the primary windings 111, 131 of the lateral legs 11, 13. Furthermore, the winding direction of the primary and secondary windings 121, 122 of the central leg 12 is inverted with respect to that of the windings 111, 112, 131, 132 of the lateral legs 11, 13.

By virtue of the architecture according to the invention, inter-leg jumps of magnetic flux are avoided. Specifically, as FIG. 5 shows, instead of getting concentrated in the central leg 12, as in FIG. 4, the magnetic-flux components created in the various legs 11, 12, 13 repulse each other pairwise. Therefore, the magnetic flux created in the lateral legs 11, 13 does not jump to the central leg 12.

Thus, the magnetic flux in the central leg 12 does not increase and the risk of overheating is consequently decreased.

One advantage associated with implementation of the invention according to the embodiment of FIG. 5 resides in the use of a standard E-shaped core, because the latter is easy to integrate mechanically and easy to cool via standard cooling technologies, and in particular via a cooling pool, as is known, allowing adequate cooling of the windings and of the core to be obtained.

It will moreover be noted that a three-phase electric transformer with an E-shaped core of linear form is not symmetric, in the sense that the phases formed on the lateral legs 11, 13 are further from each other than from the central leg 12. In contrast, in a triangular electric transformer, in particular when the triangle is equilateral, the phases are equidistant because the legs are too. In the case of an E-shaped electric transformer, the present invention is all the more recommendable in that it prevents the leakage magnetic flux from taking the same magnetic path as the controlled magnetic flux. By virtue of the invention, the leakage magnetic flux does not interfere with the controlled magnetic flux. In other words, the leakage magnetic flux does not counteract the controlled magnetic flux and does not create additional losses.

In the case of a triangular transformer, in particular when the triangle is equilateral, by virtue of the invention, an external inductive component may be dispensed with. Furthermore, in this case, all the legs are equidistant.

Such an electric transformer, according to the invention, as described above, may advantageously be integrated into a piece of electric equipment, in particular for a motor vehicle, in particular an electric charger or a power converter.

Furthermore, in the case of an E-shaped electric transformer, such an electric transformer according to the invention may easily be integrated into a casing of a piece of electric equipment comprising a cooling module with a cavity forming a cooling pool housing said electric transformer.

1. A magnetic component comprising two ferromagnetic half-cores stacked and superposed to form a ferromagnetic core comprising three legs, namely two first legs and one second leg, each leg being formed from two facing half-legs separated by a gap, each leg comprising a primary winding and a secondary winding having a winding direction, on each of the half-legs forming said leg, respectively, the magnetic component being characterized in that, on the second leg, the primary winding and the secondary winding and their winding directions are inverted with respect to those of the first legs.

2. The magnetic component as claimed in claim 1, wherein the two ferromagnetic half-cores have what is referred to as a “triangular” arrangement in which, in each ferromagnetic half-core, the three legs forming each half-core are at 60° from each other, respectively.

3. The magnetic component as claimed in claim 1, wherein the two ferromagnetic half-cores have an E shape.

4. An electric transformer comprising a magnetic component as claimed in claim 1.

5. A piece of electric equipment comprising an electric transformer as claimed in claim 4.

6. The piece of electric equipment as claimed in claim 5, comprising a cooling module comprising a cavity forming a cooling pool housing said electric transformer.

7. The piece of electric equipment as claimed in claim 5, forming an electric charger.

8. The piece of electric equipment as claimed in claim 5, forming a power converter.

9. An electric transformer comprising a magnetic component as claimed in claim 2.

10. The piece of electric equipment as claimed in claim 6, forming an electric charger.

11. The piece of electric equipment as claimed in claim 6, forming a power converter.

12. An electric transformer comprising a magnetic component as claimed in claim 3.

13. The piece of electric equipment as claimed in claim 7, forming a power converter.
